(19) United States
(12) Patent Application Publication
(10) Pub. No.: US 2025/0312708 A1
(43) Pub. Date: Oct. 9, 2025

(54) METHOD OF REDUCING AMMONIA IN WATER WASTE STREAMS

(71) Applicant: Koch Modular Process Systems, LLC, Paramus, NJ (US)

(72) Inventor: Christopher Rentsch, Paramus, NJ (US)

(21) Appl. No.: 19/070,067

(22) Filed: Mar. 4, 2025

Related U.S. Application Data
(60) Provisional application No. 63/631,015, filed on Apr. 8, 2024.

(51) Int. Cl. B01D 3/32; B01D 3/06; B01D 3/38; C02F 1/04; C02F 1/06; C02F 101/16

(52) U.S. Cl. CPC B01D 3/324; B01D 3/06; B01D 3/38; C02F 1/043; C02F 1/06; C02F 2101/16

(57) ABSTRACT

Water having ammonia therein even in the presence of non-volatile weak acid may be reduced to from a concentration of at least about 0.1% by weight to less than 300 ppm by introducing the water contaminated with ammonia and ammonium into a fractionation column having a top and bottom, and heating the contaminated water at least in part by steam introduced below the contaminated water in the fractionation column at a pressure within the fractionation column being from 5 psi to 100 psi such that the contaminated water is heated to a temperature sufficient to liberate ammonia to realize a bottom product having an ammonia and ammonium concentration of less than about 300 parts per million by weight and a top gas comprised of ammonia and steam substantially in the absence of the weak acid. The process desirably is performed in the substantial absence of a strong acid.

### CROSS REFERENCE TO PRIOR APPLICATIONS

This application claims priority to U.S. Provisional Patent Application No. 63/631,015 filed on Apr. 8, 2024, the contents of which are incorporated herein in their entirety.

### FIELD

The invention relates to methods for reducing ammonia or ammonium in water such as commonly found in industrial, biological or agricultural processes. The method may also be used to recover ammonia.

The invention relates to methods for reducing ammonia or ammonium in water such as commonly found in industrial, biological or agricultural processes. The method may also be used to recover ammonia.

### BACKGROUND

Methods to reduce ammonia from water streams to low levels that are acceptable to be released to the environment has required the addition of caustic to raise the pH of the water by use of a sufficiently basic compound such as caustic (alkali hydroxide) or alkaline earth hydroxide (e.g., lime) allowing for the efficient release and separation of ammonia by distillation such as described by U.S. Pat. No. 4,111,759 and CN103693797.

Methods for recovering ammonia from gases produced in industrial processes such as from coke ovens or production of urea is described in GB 1,018,003 and U.S. Pat. Nos. 3,024,090 and 8,814,988. These processes absorb the ammonia in a gas by washing with water having a conjugate acid-base pair (e.g., H₂PO₄⁻/HPO₄²₋) at high concentrations (e.g., 1 to 5 M) with the washing water being regenerated by removing a portion of the absorbed ammonia by stripping, at elevated temperatures and pressures.

The reduction of ammonia, after pre-stripping of other components, in certain waste streams specifically containing carbon dioxide has been described by GB 1,412,085. In this process, the weak acid (carbon dioxide) is removed at or faster than the ammonia making the liquor having a stable pH or more alkaline pH as the fractionation progresses.

Some industrial processes waste streams, such as in the biological (fermentation) and agricultural industries, may have an undesirable amount of ammonia and a substantial amount of non-volatile weak acids and other compounds that have required the use of substantial amounts of caustic making the process prohibitively expensive to treat sufficiently for release to the environment. Consequently, it would be desirable to provide an efficient cost effective method for reducing ammonia in water streams (e.g., waste or reusable industrial streams) comprised of weak non-volatile acids to low levels without the costly use of caustic or pre-removal of the non-volatile weak acids.

### SUMMARY

A method for reducing ammonia and ammonium from water having non-volatile weak acids has been discovered in the absence of the addition of a base such as an alkaline earth hydroxide (e.g., lime) or alkali hydroxide (e.g., caustic). Illustratively, the method may result in low concentrations of the water contaminated with ammonia/ammonium (contaminated water herein) even though the concentration of the ammonia/ammonium may be in excess of 0.1%, 1% or 2% to any common amount arising from industrial streams including agricultural processes such as 25%, 15%, 10% or 5% by weight of ammonia/ammonium even in the presence of a non-volatile weak acid in the contaminated water. A substantially non-volatile weak acid is one that is not substantially stripped during the process to reduce the ammonia/ammonium from the contaminated water (e.g., at least about 90%, 95% or 99% by weight of the weak acid is not removed from the contaminated water when reducing the ammonia/ammonium).

An illustration is a method of reducing ammonia in water comprising:
(i) introducing a contaminated water comprised of ammonia and ammonium in an amount of at least about 0.1% to at most about 10% by weight and a weak acid such that the contaminated water has a pH of 1 to 10 into a fractionation column having a top and bottom, and
(ii) heating the contaminated water at least in part by steam introduced below the contaminated water in the fractionation column at a pressure within the fractionation column being from 5 psi to 100 psi such that the contaminated water is heated to a temperature sufficient to liberate ammonia to realize a bottom product having an ammonia and ammonium concentration of less than about 300 parts per million by weight and a top gas comprised of ammonia and steam substantially in the absence of the weak acid. Substantially in the absence of the weak acid generally correlates with the amount of weak acid remaining in the bottom product having the amount of weak acid as described in the previous paragraph and is readily shown by the top gas after being condensed (“top condensate”) having a pH greater than the bottom product, which is typically at least 1, 2, 3 or even 4 pH units greater in the top condensate compared to the bottom product.

Another illustration is a method of reducing ammonia in water comprising:
(i) introducing a contaminated water comprised of ammonia and ammonium in an amount of at least about 0.1% by weight in the absence of a strong acid into a fractionation column having a top and bottom and having a pH of at least about 1 to at most about 10, and
(ii) heating the contaminated water at least in part by steam introduced below the contaminated water introducing into the fractionation column, the pressure within the fractionation column being at least 5 psi to less than 100 psi such that the contaminated water is heated to a temperature sufficient to liberate ammonia to realize a bottom product having an ammonia and ammonium concentration of at most about 300 parts per million by weight and the fractionation column has at least 5 stages between the bottom product and the introducing of the contaminated water.

Stages of a fractionation column herein refer to the theoretical stages as given by McCabe and Thiele in Industrial and Engineering Chemistry. 17 (6): 605-611 (1925), with it being understood that in practice such stages require significantly more trays in a tray fractionation column due to the inefficiency of the trays versus the theoretical stages and may depend on many factors such as the type of tray and in a packed bed fractionation column the type of packing, with the efficiency typically ranging from 30% to 85%.

### DESCRIPTION OF THE DRAWINGS

FIG. 1 is an illustration of an apparatus useful for performing the method of the invention.

FIG. 2 shows the results from the method of this invention and not of this invention.

FIG. 3 shows the results from the method of this invention and not of this invention.

### DETAILED DESCRIPTION

The explanations and illustrations presented herein are intended to acquaint others skilled in the art with the invention, its principles, and its practical application. The specific embodiments of the present disclosure as set forth are not intended to be exhaustive or limit the scope of the disclosure. It is understood that any reference to a property or characteristic of a material may be determined by any suitable methods such as commonly used methods and standards for such characteristics. For example, pH may be determined by any commonly accepted method without citing a particular standard and likewise the amount of ammonia/ammonium present in water may determined by any suitable method such as ASTM D1426-15(2021)e1.

One or more as used herein means that at least one, or more than one, of the recited components may be used as disclosed. It is understood that the functionality of any ingredient or component may be an average functionality due to imperfections in raw materials, incomplete conversion of the reactants and formation of by-products.

Generally, the contaminated water is comprised of ammonia and ammonium in an amount of at least 0.1% by weight to any commonly encountered amount in industrial processes such as 25% by weight. The amount typically is at least about 0.25%, 0.5%, 1% or 2% to about 20%, 15%, 10% or 5% by weight. The method is particularly suitable for when the contaminated water is comprised of a weak acid that is non-volatile as described above. The amount of weak acid may be any that is commonly encountered in industrial process such as those in biological fermentation and agricultural processes. Generally, the amount of weak acid may be any that reduces the pH (e.g., at least 0.1 pH) of the contaminated water in the absence of the weak acid. The pH of the contaminated water typically being 1, 2, 2.5 or 3 to 10, 9, 8, 7, 6.5 or 6.

The weak acid may be any compound that is a weak acid displaying a pKa of about 1, 1.5, 2, 2.5 or 3 to 7, 6.5 or 6 with it being understood that pKa is the logarithm of the acid disassociation constant in water. It is also understood that in some cases where multiple carboxylic acid groups are contained in a polymer, the pKa may be difficult to ascertain, but these are contemplated herein. The weak acid may be multifunctional (i.e., 2 or more acid groups per molecule), but generally is comprised a monofunctional acid. The weak acid may be saturated or unsaturated. The weak acid may be any carboxylic acid such as a natural occurring carboxylic acid. For example, the carboxylic acid may be abictic acid, alginic acid, gallic acid, azelaic acid, caffeic acid, malic acid, pyruvic acid, niacin, citric acid, biotin, abictic acid, cholic resin, pectin, alginic acid, gum rosin (a mixture of naturally occurring natural acids) or combination thereof. The fatty acid may be any fatty acid derived from any animal fat or vegetable oil and may be saturated or unsaturated. Exemplary oils include linseed, palm, coconut, palm, olive, tung, soybean, peanut, sunflower, cotton seed, rapeseed, or combination thereof. Any fatty acid derived from the aforementioned oils and fats may be used (e.g., isostearic acid). In an embodiment, the fatty acid is dimerized to form a dimer, trimer acid or higher polymeric acids. Typically, readily available dimer acids contain some small fraction of monomeric acid, trimer acid and higher polymeric acid.

The weak acid may be any carboxylic acid such as mono, dicarboxylic or higher order (e.g., tri or tetra) carboxylic acids (e.g., ascorbic acid and ethylenediaminetetraacetic acid). Illustratively, the carboxylic acid may have linear or branched alkane chains of 3 or 5 to 30, 20 or 15 carbons or mixtures thereof. Examples may include hexanoic, hexanedioic acid, heptanoic acid, heptanedioic acid, octanoic acid, octanedioic acid, nonanoic acid, nonanedioic acid, decanoic acid, decanedioic acid, 2,3-dimethylbutancoic acid, 2,3-dimethylbutancoic acid, 2,3-dimethylbutanedioic, 2,2-dimethylbutancoic acid, 2,2-dimethylbutanedioic acid, 3-methylheptancoic acid, 3-methylheptanedioic acid or mixtures thereof.

The weak acid may be a sterically hindered carboxylic acid with a short and highly branched alkyl chemical structure such as 2,2,3,5-Tetramethylhexanoic acid, 2,4-Dimethyl-2-isopropylpentanoic acid, 2,5-Dimethyl-2-ethylhexanoic acid, 2,2-Dimethyloctanoic acid, or 2,2-Diethylhexanoic acid.

The weak acid may also be a carboxyl containing: polyether, polyester, polyether-ester, polyamide, conjugated diene polymer or conjugated diene copolymer, polyurethane, polystyrene, polyolefin, silicone or combination thereof. The weak acid may also be a polysaccharide, polypeptide, protein, phosphoric acid, nitrous acid, sulfurous acid, oxalic acid, chromic acid, hydrofluoric acid, hydrogen sulfide or combination of these or any of the aforementioned.

The contaminated water may be comprised of other compounds that do not interfere with the removal of the ammonia such as solid compounds and commonly encountered contaminants such as strong acids in sufficiently small amounts that do not interfere with the stripping of the ammonia and ammonium, greases, oils and waxes.

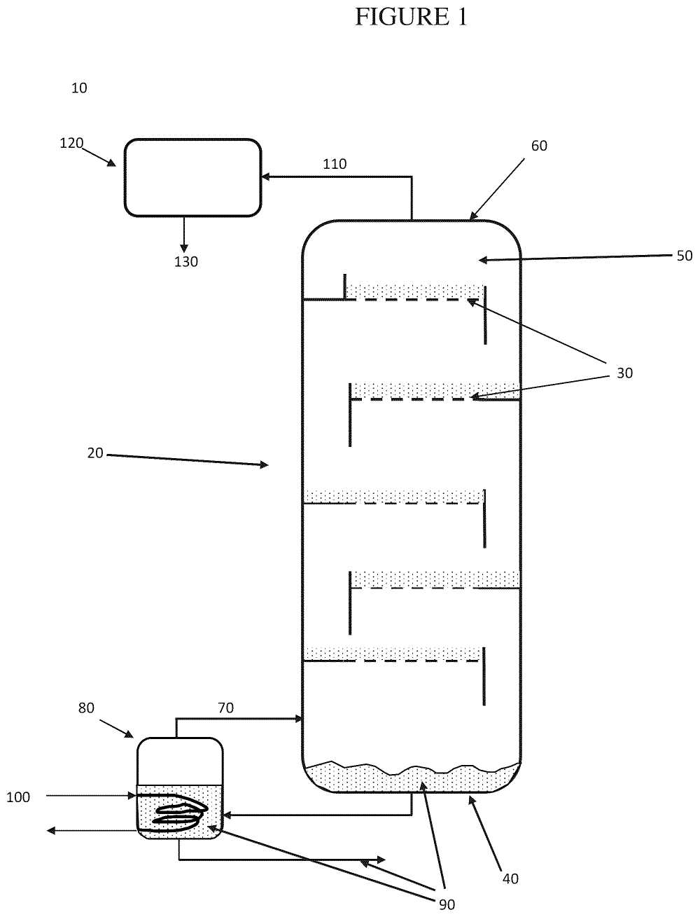

To illustrate the method FIG. 1 displays an illustrative fractionation apparatus 10 suitable to practice the method. The fractionation apparatus has a fractionation column 20 comprised of 6 stages illustrated by trays 30 and the bottom 40 of the fractionation column 20. In the method the contaminated water 50 is introduced above and in this instance at the top 60 of the fractionation column 20 (fractionation column top), but need not be so long as the there is sufficient stages (“stripping stages”) to realize the desired reduction in ammonia/ammonium. Steam 70 is introduced to the fractionation column 20 below the contaminated water 50 and in this instance at the bottom 40 of the fractionation column 20, but in the same manner, the steam may be introduced elsewhere along the fractionation column so long as there are sufficient stripping stages. In this illustration the steam is introduced from a reboiler 80 containing bottom product 90 that is vaporized to form steam 70. The heating source 100 to the reboiler 80 may be any useful for supplying heat with an external steam source and heat exchanger in the reboiler being an example. Steam 70 or other heating source may be directly introduced to the bottom product 90 at the fractionation column bottom 90 and may use a heat exchanger as in the in reboiler 80. Preferably the steam is separately introduced along the length of the fractionation column above the bottoms product 90 and may come from any source including a reboiler 80. The separately introduced steam is preferably the primary heating source (>50% and preferably at least 75%, 90% to all of the heat) of the heat provided. The top gas 110 is removed and may be delivered to condenser 120 to form top condensate 130 comprised of ammonia and ammonium, which may be reused or recycled in the process. Alternatively, the top gas may be directly reused or the ammonia destroyed directly therefrom if desired.

Generally, the pressure within the fractionation column is from 5, 10, 20, 25, to 100, 90, 80 or 75 psi. Herein, pressure is the gauge pressure (psig) unless otherwise specifically specified. The temperature may be any suitable temperature to realize the steam pressure and typically may be from about 104° C. to 175° C.

The number of stages may be any suitable, but it has been discovered that at least 5 stages and in many instance higher stages may be required such as 7, 10, 15 or even 20. It also has surprisingly been discovered that the number of trays may not realize the efficiency common in typical distillation processes. That is, it has been discovered that substantially more distillation trays may be required to realize the theoretical stages to realize the reduction in ammonia/ammonium in the bottom product. For example, the number of trays required to realize the desired reduction in ammonia, particularly for contaminated water having pH of less than 10 and in particular pH less than 7, may be at least 10, 15, 20, 25 or even 30 to any practicable amount such as 200 or 100.

The trays may be any suitable distillation tray such as those commercially available. For example, the tray may be a sieve, fixed valve, floating valve tray and combination thereof. Generally, it is preferable for the tray to be a fixed valve or floating valve tray and the selection thereof may be dependent on flow rate desired and other contaminants present in the contaminated water (e.g. solid contaminants). In other embodiments packing may be used and the amount of packing may be any suitable such as those commercially available and in like manner may require substantially larger amounts of packing commonly expected in typical distillation processes.

The method realizes the reduction of the ammonia/ammonium to less than 300ppm by weight and may reduce the amount of ammonia/ammonium to less than 250 ppm, 200 ppm, 150 ppm, 100 ppm, 75 ppm, 50 ppm, 25 ppm or even 10 ppm even in the presence of the weak acid. As described above, the method is particularly suitable for contaminated water comprised of a non-volatile weak acid and particularly in the substantial absence of a volatile weak acid such as carbonic acid as well as in the absence of the introduction of a gas such as an inert gas, air, carbon dioxide or other species that form as a result of the introduction of such gases (e.g., ammonium carbamate, ammonium carbonate and ammonium decarbonate). Illustratively, the process realizes a bottom product that has a pH that is less than the pH of the contaminated water. For example, the bottom product may have a pH that is at least 1, 2, 3, 4 or even 5 pH units less than the contaminated water and the bottom product may have a pH from 7, 6.5, 6, 5.5, 5, 5, 4 to 1 or 2.

### ILLUSTRATIONS

Illustration 1. A method of reducing ammonia in water comprising,
(i) introducing a contaminated water comprised of ammonia and ammonium in an amount of at least about 0.1% to at most about 25% by weight and a weak acid such that the contaminated water has a pH of 1 to 10 into a fractionation column having a top and bottom, and
(ii) heating the contaminated water at least in part by steam introduced below the contaminated water introducing into the fractionation column at a pressure within the fractionation column being from 5 psi to 100 psi such that the contaminated water is heated to a temperature sufficient to liberate ammonia to realize a bottom product having an ammonia and ammonium concentration of less than about 300 parts per million by weight and a top gas comprised of ammonia and steam substantially in the absence of the weak acid.

Illustration 2. The method of illustration 1, wherein the weak acid is substantially non-volatile at the pressure and temperature within the fractionation column.

Illustration 3. The method of illustrations 1 or 2, wherein the weak acid has a pKa of 1 to 7.

Illustration 4. The method of illustration 3, wherein the weak acid has a pKa of 2 to 6.5.

Illustration 5. The method of any one of the preceding illustrations, wherein the pH of the contaminated water is at least 2 to 9.

Illustration 6. The method of any one of the preceding illustrations, wherein a portion of the contaminated water is introduced at the top of the fractionation column.

Illustration 7. The method of illustration 6, wherein all the contaminated water is introduced at the top of the fractionation column.

Illustration 8. The method of any one of the preceding illustrations, wherein the heating of the contaminated water is solely provided by the introducing of a separate stream of steam.

Illustration 9. The method of any one of the preceding illustrations, wherein the top gas is condensed to form a top condensate having a pH greater than the bottom product's pH.

Illustration 10. The method of any one of the preceding illustrations wherein the fractionation column is a fractionation column comprised of trays.

Illustration 11. The method of any one of the preceding illustrations, wherein the steam is directly introduced at the bottom of the fractionation column.

Illustration 12. The method of any one of the preceding illustrations, wherein the pressure is at least 10 psi to 90 psi.

Illustration 13. The method of any one of the preceding illustrations, wherein the weak acid is comprised of one or more of a carboxylic acid, phosphoric acid, nitrous acid and hydrofluoric acid and sulfurous acid.

Illustration 14. The method of any one of the preceding illustrations, wherein the weak acid is comprised of a carboxylic acid

Illustration 15. The method of any one of the preceding illustrations, wherein the weak acid is comprised of a naturally occurring weak acid.

Illustration 16. The method of any one of the preceding illustrations wherein, the bottom product's pH is is less than the contaminated water's pH.

Illustration 17. The method of illustration 16, wherein the bottom product's pH is at least 1 pH less than the contaminated water's pH.

Illustration 18. The method of any of the preceding illustrations, wherein the amount of ammonia and ammonium is at least 1% by weight.

Illustration 19. The method of illustration 18, wherein the amount is at most about 10% by weight.

Illustration 20. The method of any one of the preceding illustrations, wherein the introducing and heating of the contaminated water is in the absence of adding any alkaline earth hydroxide and alkali hydroxide.

Illustration 21. A method of reducing ammonia in water comprising,
(i) introducing a contaminated water comprised of ammonia and ammonium in an amount of at least about 0.1% by weight and in the absence of a strong acid into a fractionation column having a top and bottom and having a pH of at least about 1 to at most about 10, and
(ii) heating the contaminated water at least in part by steam introduced below the contaminated water introducing into the fractionation column, the pressure within the fractionation column being at least 5 psi to less than 100 psi such that the contaminated water is heated to a temperature sufficient to liberate ammonia to realize a bottom product having an ammonia and ammonium concentration of at most about 300 parts per million by weight and the fractionation column has at least 5 stages between the bottom product and the introducing of the contaminated water.

Illustration 22. The method of illustration 21, wherein the contaminated water is comprised of a weak acid that is substantially non-volatile at the pressure and temperature within the fractionation column.

Illustration 23. The method of illustration 22, wherein the weak acid has a pKa of 1 to 7.

Illustration 24. The method of illustration 23, wherein the weak acid has a pKa of 2 to 6.5.

Illustration 25. The method of any one of illustrations 21 to 24, wherein the pH of the contaminated water is 1 to 7.

Illustration 26. The method of any one of the preceding illustrations, wherein a portion of the contaminated water is introduced at the top of the fractionation column.

Illustration 27. The method of illustration 26, wherein all the contaminated water is introduced at the top of the fractionation column.

Illustration 28. The method of any one of illustrations 21 to 28, wherein the heating of the contaminated water is solely provided by introducing a separate stream of steam introduced below the contaminated water.

Illustration 29. The method of any one of illustrations 21 to 28, wherein the top gas is condensed to form a top condensate having a pH greater than the bottom product's pH.

Illustration 30. The method of any one of illustrations 21 to 29 wherein the fractionation column is a tray fractionation column.

Illustration 31. The method of illustration 30, wherein the trays are comprised of one or more of a fixed valve tray, floating valve tray and sieve tray.

Illustration 32. The method of illustration 31, wherein the trays are fixed valve trays.

Illustration 33. The method of any one of illustrations 22 to 32, wherein the weak acid is comprised of one or more of a carboxylic acid, phosphoric acid, nitrous acid and hydrofluoric acid and sulfurous acid.

Illustration 34. The method of illustration 33, wherein the weak acid is comprised of a carboxylic acid.

Illustration 35. The method of any one of illustrations 21 to 34, wherein the fractionation column has at least 10 stages.

Illustration 36. The method of any one of illustrations 21 to 35 wherein, the bottom product's pH is less than the contaminated water's pH.

Illustration 37. The method of illustration 36, wherein the bottom product's pH is less than 7.

Illustration 38. The method of any one of illustrations 21 to 37, wherein the amount of ammonia and ammonium is at least 1% to 10% by weight.

Illustration 39. The method of any one of illustrations 21 to 38, wherein the introducing and heating is the absence of introducing an alkali hydroxide and alkaline hydroxide.

### EXAMPLES

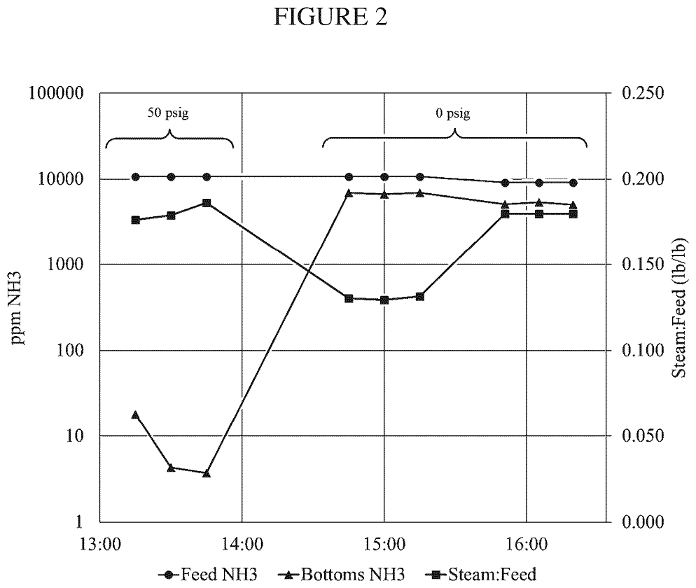

In a fractionation column having 36 sieve trays contaminated water having 1% by weight ammonia and an amount of phosphoric acid sufficient to reduce the pH of the contaminated water to 7 is introduced at the top of the fractionation column with the pressure being run at 0 psi and 50 psi. The steam feed ranges from about 14.2 to 9.5 pounds per hour and the feed ranges from about 52.9 to 76.3 pounds per hour. FIG. 2 shows the results where it is evident that the use of pressure (50 psi) in the absence of the addition of caustic having sufficient amount of distillation trays realizes ammonia/ammonium concentration in the bottom product of less than 10 ppm whereas fractionation at 0 psi gauge only about 40% of ammonia/ammonium is removed.

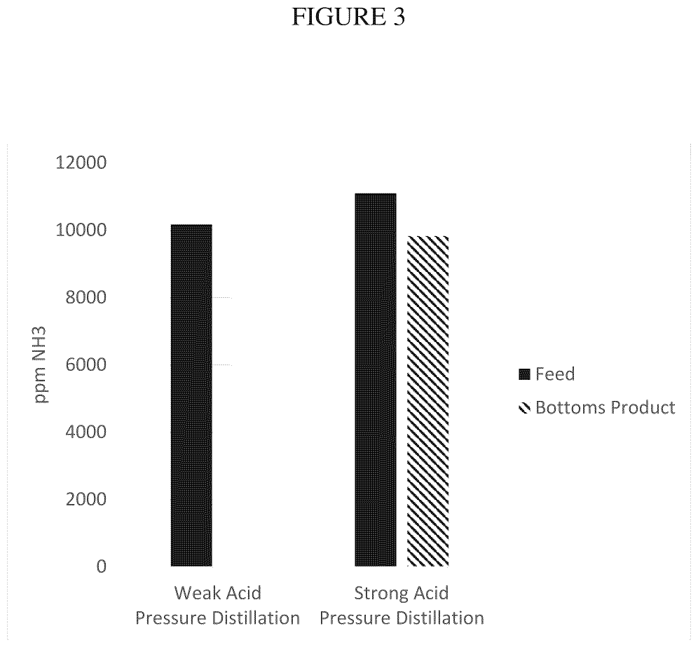

In the same fractionation column as described in the previous paragraph, contaminated water having 1% by weight ammonia is adjusted to a pH of 7 using sulfuric acid (strong acid) and the fractionation is performed in the same manner at 50 psi steam, feed of 76 pounds/hour, and steam feed of about 13.6 pounds/hour. The results for this fractionation is shown in FIG. 3 compared to the fractionation results shown in FIG. 2 when using a weak acid at essentially the same conditions. From this it is readily apparent that the use of a weak acid under the fractionation surprisingly realizes essentially complete removal of the ammonia whereas a strong acid such as sulfuric acid removes less than 10% of the ammonia from the bottom product. That is, the presence of a strong acid is deleterious to the removal of the ammonia/ammonium and it is desirable for the contaminated water to essentially be in the absence of a strong acid, with the amount of strong acid being present in an amount that is insufficient to lower the pH by 1, 0.5 or 0.1 pH units to essentially an undetectable amount (e.g., less than 1 part per million by weight). A strong acid is one that completely dissociates in water such as sulfuric acid, hydrochloric acid, perchloric acid, hydroiodic acid, hydrobromic acid, chloric acid and nitric acid.

What is claimed is:

1. A method of reducing ammonia in water comprising,
(i) introducing a contaminated water comprised of ammonia and ammonium in an amount of at least about 0.1% to at most about 25% by weight and a weak acid such that the contaminated water has a pH of 1 to 10 into a fractionation column having a top and bottom, and
(ii) heating the contaminated water at least in part by steam introduced below the contaminated water introducing into the fractionation column at a pressure within the fractionation column being from 5 psi to 100 psi such that the contaminated water is heated to a temperature sufficient to liberate ammonia to realize a bottom product having an ammonia and ammonium concentration of less than about 300 parts per million by weight and a top gas comprised of ammonia and steam substantially in the absence of the weak acid.

2. The method of claim 1, wherein the weak acid is substantially non-volatile at the pressure and temperature within the fractionation column.

3. The method of claim 1, wherein the weak acid has a pKa of 2 to 6.5.

4. The method of claim 1, wherein the pH of the contaminated water is from 2 to 9.

5. The method of claim 1, wherein all the contaminated water is introduced at the top of the fractionation column and the heating of the contaminated water is solely provided by the introducing of a separate stream of steam.

6. The method of claim 1, wherein the fractionation column is a fractionation column comprised of trays.

7. The method of claim 1, wherein the pressure is at least 10 psi to 90 psi.

8. The method of claim 1, wherein the weak acid is comprised of one or more of a carboxylic acid, phosphoric acid, nitrous acid and hydrofluoric acid and sulfurous acid.

9. The method of claim 1, wherein the weak acid is comprised of a naturally occurring weak acid.

10. The method of claim 1, wherein the bottom product's pH is at least 1 pH less than the contaminated water's pH.

11. The method of claim 1, wherein the introducing and heating of the contaminated water is in the absence of adding any alkaline earth hydroxide and alkali hydroxide and substantially in the absence of a strong acid.

12. A method of reducing ammonia in water comprising,
(i) introducing a contaminated water comprised of ammonia and ammonium in an amount of at least about 0.1% by weight and essentially in the absence of a strong acid into a fractionation column having a top and bottom and having a pH of at least about 1 to at most about 10, and
(ii) heating the contaminated water at least in part by steam introduced below the contaminated water introducing into the fractionation column, within the fractionation column is a pressure of at least 5 psi to less than 100 psi such that the contaminated water is heated to a temperature sufficient to liberate ammonia to realize a bottom product having an ammonia and ammonium concentration of at most about 300 parts per million by weight and the fractionation column has at least 5 stages between the bottom product and the introducing of the contaminated water.

13. The method of claim 12, wherein the contaminated water is comprised of a weak acid that is substantially non-volatile at the pressure and temperature within the fractionation column.

14. The method of claim 12, wherein a weak acid is introduced to the contaminated water, the weak acid having a pKa of 1 to 7.

15. The method of claim 12 wherein the fractionation column is a tray fractionation column.

16. The method of claim 15, wherein the trays are comprised of one or more of a fixed valve tray, floating valve tray and sieve tray.

17. The method of claim 16, wherein the trays are fixed valve trays.

18. The method of claim 12, wherein the contaminated water is comprised of a weak acid that is comprised of one or more carboxylic acid, phosphoric acid, nitrous acid and hydrofluoric acid and sulfurous acid.

19. The method of claim 12, wherein the fractionation column has at least 10 stages.

20. The method of claim 1, wherein the introducing and heating is in the absence of introducing an alkali hydroxide and alkaline hydroxide.
